(19) United States
(12) Patent Application Publication
(10) Pub. No.: US 2026/0268915 A1
(43) Pub. Date: Sep. 10, 2026

(54) LOW CODING RATE PARAMETRIC SPATIAL AUDIO ENCODING

(71) Applicant: NOKIA TECHNOLOGIES OY, Espoo (FI)

(72) Inventor: Adriana VASILACHE, Tampere (FI)

(21) Appl. No.: 19/165,524

(22) PCT Filed: Feb. 13, 2024
(86) PCT No.: PCT/EP2024/053523

§ 371 Date: Sep. 15, 2025

(30) Foreign Application Priority Data
Mar. 24, 2023 (GB) 2304286.4

(51) Int. Cl. G10L 19/002; G10L 19/032

(52) U.S. Cl. CPC G10L 19/002; G10L 19/032

(57) ABSTRACT

An apparatus configured to: receive a direction value for a time frame of an audio object; compare, as a first comparison, a bit allocation against a threshold bit allocation value; depending on the first comparison, either quantize the direction value for the time frame of the audio object with a quantizer according to the bit allocation, or compare, as a second comparison, the direction value for the time frame of the audio object with a direction value for a previous time frame of the audio object; and depending on the second comparison quantize the direction value for the time frame with the quantizer according to the bit allocation and signal the second comparison.

### FIELD

The present application relates to apparatus and methods for spatial audio representation and encoding, but not exclusively for audio representation for an audio encoder.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and for example a stereo or mono signal can be generated from the microphone array signals to be conveyed with the spatial metadata. The stereo signal could be encoded, for example, with an AAC encoder and the mono signal could be encoded with an EVS encoder. A decoder can decode the audio signals into PCM signals and process the sound in frequency bands (using the spatial metadata) to obtain the spatial output, for example a binaural output.

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is provided an apparatus comprising means configured to: receive a direction value for a time frame of an audio object; compare, as a first comparison, a bit allocation against a threshold bit allocation value; depending on the first comparison, either quantize the direction value for the time frame of the audio object with a quantizer according to the bit allocation, or compare, as a second comparison, the direction value for the time frame of the audio object with a direction value for a previous time frame of the audio object; and depending on the second comparison quantize the direction value for the time frame with the quantizer according to the bit allocation and signal the second comparison.

The means configured to depending on the second comparison quantize the direction value for the time frame with the quantizer according to the bit allocation and signal the comparison may be configured to: quantize the direction value for the time frame with the quantizer according to the bit allocation when the second comparison indicates the direction value for the time frame of the audio object is different from the direction value for the previous time frame of the audio object and set a signal flag to indicate that the direction value for the time frame differs from the direction value for the previous time frame; and set a signal flag to indicate that the direction value for the time frame is the same as the direction value for the previous time frame when the second comparison indicates the direction value for the time frame of the audio object is the same as the direction value for the previous time frame of the audio object.

The means configured to depending on the first comparison, either quantize the direction value for the time frame of the audio object with a quantizer according to the bit allocation, or compare, as a second comparison, the direction value for the time frame of the audio object with a direction value for a previous time frame of the audio object maybe configured to: quantize the direction value for the time frame of the audio object with a quantizer according to the bit allocation when the bit allocation for the quantization of the direction value is not less than the threshold bit allocation value; and compare the direction value for the time frame of the audio object with a direction value for a previous time frame of the audio object as the second comparison when the bit allocation for the quantization of the direction value is less than the threshold bit allocation value.

The quantizer maybe a spherical grid quantizer wherein the spherical grid is formed by covering the sphere with smaller spheres, wherein the smaller spheres define the points of the spherical grid.

The direction value may comprise an azimuth value and an elevation value.

According to a second aspect there is provided an apparatus comprising means configured to: compare a bit allocation for a direction value index for a time frame of an audio object against a threshold bit allocation value; depending on the comparison, either decode the direction value index for the time frame of the audio object with a de-quantizer according to the bit allocation, or read a state of a signal flag associated with the direction value index for the time frame of the audio object; and depending on the state of the signal flag; either set a quantized direction value for the time frame of the audio object to be a quantized direction value for a previous time frame of the audio object, or decode the direction value index for the time frame of the audio object with a de-quantizer according to the bit allocation giving a quantized direction value for the time frame of the audio object and adjust an azimuth value of the quantized direction value for the time frame of the audio object in accordance with a quantization resolution of the azimuth value.

The means configured to adjust an azimuth value of the quantized direction value for the time frame of the audio object in accordance with a quantization resolution of the azimuth value maybe configured to: compare the product of the azimuth value of the quantized direction value for the time frame and an azimuth value of the quantized direction value for the previous time frame of the audio object, and when the product is greater than zero: determine a difference between two consecutive azimuth quantization values of the de-quantizer; when a difference between the azimuth value of the quantized direction value for the time frame and the azimuth value of the quantized direction value for the previous time frame of the audio object is greater than half the difference between two consecutive azimuth quantization values of the de-quantizer subtract the half difference between two consecutive azimuth quantization values of the de-quantizer from the azimuth value of the quantized direction value for the time frame of the audio object; and when a difference between the azimuth value of the quantized direction value for the previous time frame and the azimuth value of the quantized direction value for the time frame of the audio object is greater than half the difference between two consecutive azimuth quantization values of the de-quantizer add the half difference between two consecutive azimuth quantization values of the de-quantizer to the azimuth value of the quantized direction value for the time frame of the audio object.

The means configured to determine a difference between two consecutive azimuth quantization values of the de-quantizer maybe configured to: divide the circumference of a circle by a number of azimuth values, where the number of azimuth values is determined by the elevation value of the quantized direction value for the time frame.

The state of the signal flag indicates one of: a direction value for the time frame of the audio object differs from a direction value for the previous time frame of the audio object; or a direction value for the time frame of the audio object is the same as a direction value for the previous time frame of the audio object;

The de-quantizer is a spherical grid quantizer wherein the spherical grid is formed by covering the sphere with smaller spheres, wherein the smaller spheres define the points of the spherical grid.

According to a third aspect there is provided a method comprising: receiving a direction value for a time frame of an audio object; comparing, as a first comparison, a bit allocation against a threshold bit allocation value; depending on the first comparison, either quantizing the direction value for the time frame of the audio object with a quantizer according to the bit allocation, or comparing, as a second comparison, the direction value for the time frame of the audio object with a direction value for a previous time frame of the audio object; and depending on the second comparison quantizing the direction value for the time frame with the quantizer according to the bit allocation and signal the second comparison.

When depending on the second comparison quantize the direction value for the time frame with the quantizer according to the bit allocation and signal the comparison may comprise: quantizing the direction value for the time frame with the quantizer according to the bit allocation when the second comparison indicates the direction value for the time frame of the audio object is different from the direction value for the previous time frame of the audio object and set a signal flag to indicate that the direction value for the time frame differs from the direction value for the previous time frame; and setting a signal flag to indicate that the direction value for the time frame is the same as the direction value for the previous time frame when the second comparison indicates the direction value for the time frame of the audio object is the same as the direction value for the previous time frame of the audio object.

When depending on the first comparison, either quantizing the direction value for the time frame of the audio object with a quantizer according to the bit allocation, or comparing, as a second comparison, the direction value for the time frame of the audio object with a direction value for a previous time frame of the audio object may comprise: quantizing the direction value for the time frame of the audio object with a quantizer according to the bit allocation when the bit allocation for the quantization of the direction value is not less than the threshold bit allocation value; and comparing the direction value for the time frame of the audio object with a direction value for a previous time frame of the audio object as the second comparison when the bit allocation for the quantization of the direction value is less than the threshold bit allocation value.

The quantizer maybe a spherical grid quantizer wherein the spherical grid is formed by covering the sphere with smaller spheres, wherein the smaller spheres define the points of the spherical grid.

The direction value may comprise an azimuth value and an elevation value.

According to a fourth aspect there is provided a method comprising: comparing a bit allocation for a direction value index for a time frame of an audio object against a threshold bit allocation value; depending on the comparison, either decoding the direction value index for the time frame of the audio object with a de-quantizer according to the bit allocation, or reading a state of a signal flag associated with the direction value index for the time frame of the audio object; and depending on the state of the signal flag; either setting a quantized direction value for the time frame of the audio object to be a quantized direction value for a previous time frame of the audio object, or decoding the direction value index for the time frame of the audio object with a de-quantizer according to the bit allocation giving a quantized direction value for the time frame of the audio object and adjusting an azimuth value of the quantized direction value for the time frame of the audio object in accordance with a quantization resolution of the azimuth value.

Adjusting an azimuth value of the quantized direction value for the time frame of the audio object in accordance with a quantization resolution of the azimuth value may comprise: comparing the product of the azimuth value of the quantized direction value for the time frame and an azimuth value of the quantized direction value for the previous time frame of the audio object, and when the product is greater than zero: determining a difference between two consecutive azimuth quantization values of the de-quantizer; when a difference between the azimuth value of the quantized direction value for the time frame and the azimuth value of the quantized direction value for the previous time frame of the audio object is greater than half the difference between two consecutive azimuth quantization values of the de-quantizer subtracting the half difference between two consecutive azimuth quantization values of the de-quantizer from the azimuth value of the quantized direction value for the time frame of the audio object; and when a difference between the azimuth value of the quantized direction value for the previous time frame and the azimuth value of the quantized direction value for the time frame of the audio object is greater than half the difference between two consecutive azimuth quantization values of the de-quantizer adding the half difference between two consecutive azimuth quantization values of the de-quantizer to the azimuth value of the quantized direction value for the time frame of the audio object.

Determining a difference between two consecutive azimuth quantization values of the de-quantizer may comprise: dividing the circumference of a circle by a number of azimuth values, where the number of azimuth values is determined by the elevation value of the quantized direction value for the time frame.

The state of the signal flag may indicate one of: a direction value for the time frame of the audio object differs from a direction value for the previous time frame of the audio object; or a direction value for the time frame of the audio object is the same as a direction value for the previous time frame of the audio object;

The de-quantizer maybe a spherical grid quantizer wherein the spherical grid is formed by covering the sphere with smaller spheres, wherein the smaller spheres define the points of the spherical grid.

According to a fifth aspect there is provided an apparatus comprising at least one processor and at least one memory storing instructions that, when executed by the at least one processor, cause the system at least to: receive a direction value for a time frame of an audio object; compare, as a first comparison, a bit allocation against a threshold bit allocation value; depending on the first comparison, either quantize the direction value for the time frame of the audio object with a quantizer according to the bit allocation, or compare, as a second comparison, the direction value for the time frame of the audio object with a direction value for a previous time frame of the audio object; and depending on the second comparison quantize the direction value for the time frame with the quantizer according to the bit allocation and signal the second comparison.

According to a sixth aspect there is provided an apparatus comprising at least one processor and at least one memory storing instructions that, when executed by the at least one processor, cause the system at least to: compare a bit allocation for a direction value index for a time frame of an audio object against a threshold bit allocation value; depending on the comparison, either decode the direction value index for the time frame of the audio object with a de-quantizer according to the bit allocation, or read a state of a signal flag associated with the direction value index for the time frame of the audio object; and depending on the state of the signal flag; either set a quantized direction value for the time frame of the audio object to be a quantized direction value for a previous time frame of the audio object, or decode the direction value index for the time frame of the audio object with a de-quantizer according to the bit allocation giving a quantized direction value for the time frame of the audio object and adjust an azimuth value of the quantized direction value for the time frame of the audio object in accordance with a quantization resolution of the azimuth value.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an example encoding mode selector as shown in the system of apparatus as shown in FIG. 1 according to some embodiments;

FIG. 3 shows a flow diagram of the operation of the example encoding mode selector shown in FIG. 2 according to some embodiments;

FIG. 4 shows a flow diagram of the operation of the example first, lowest, or only MASA bitrate encoding mode shown in FIG. 4 according to some embodiments;

FIG. 5 shows a flow diagram of the operation of the example second, lower, or object information encoding mode shown in FIG. 4 according to some embodiments;

FIG. 6 shows a flow diagram of the operation of the example third, higher, or single object encoding mode shown in FIG. 4 according to some embodiments;

FIG. 7 shows a flow diagram of the operation of the example fourth, highest, or independent object and multi-input encoding mode shown in FIG. 4 according to some embodiments;

FIG. 8 shows schematically an example audio object metadata encoder as shown in FIG. 1 according to some embodiments;

FIG. 9 shows a flow diagram of the operation of the example audio object metadata encoder encoding mode selector shown in FIG. 8 according to some embodiments;

FIG. 10 shows a flow diagram of the operation of the example encoder determiner and the low rate encoder in FIG. 8 according to some embodiments;

FIG. 11 shows schematically an example audio object direction value decoder according to some embodiments;

FIG. 12 shows a flow diagram of an operation of the example low-rate decoder in FIG. 11 according to some embodiments; and

FIG. 13 shows an example device suitable for implementing the apparatus shown in previous figures.

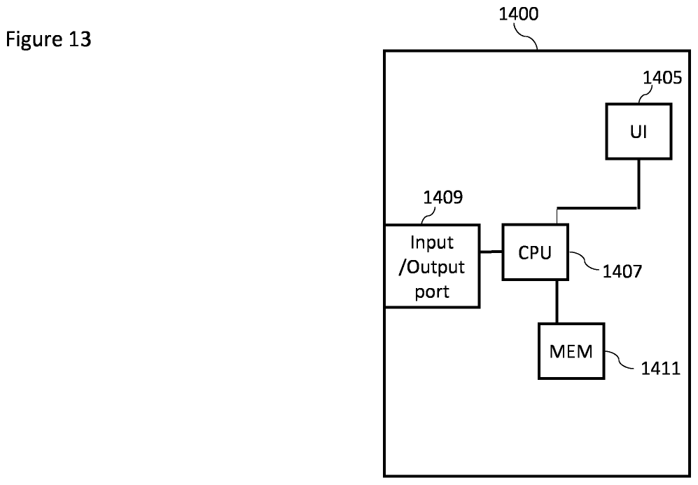

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency. It is expected to support channel-based audio and scene-based audio inputs including spatial information about the sound field and sound sources. In the following the example codec is configured to be able to receive multiple input formats. In particular the codec is configured to obtain or receive a multi audio signal (for example received from a microphone array, or as a multi-channel audio format input, an ambisonics format input) and one or more audio object signal (these can also be called an independent stream with metadata-ISM format). Furthermore, in some situations the codec is configured to handle more than one input format at a time. This combined (input) format mode can, for example, enable simultaneous encoding of two different audio input formats. An example of two different audio input formats being currently considered is the combination of the MASA format with audio object format. Metadata-Assisted Spatial Audio (MASA) is an example of a parametric spatial audio format and representation suitable as an input format for IVAS.

It can be considered as an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example, a reasonable design choice which is able to produce a good quality output is one where the spatial metadata comprises one or more directions for each time-frequency subframe (and associated with each direction direct-to-total ratios, spread coherence, distance values etc) are determined.

The concept as discussed in further detail herein is the definition of a multi-rate coding model which provides for encoding of a combined format at various bitrates. This coding model enables a parametric encoding of the audio object input that includes variable rate encoding for an object direction parameter based on a determined priority of the object and the available bitrate. Thus, there comprises embodiments as discussed in further detail herein of apparatus and methods for defining a quantization resolution of the object metadata as a function of both the MASA-to-total energy ratios and ISM ratios. Based on these parameters a priority value is calculated for each object and it is used to change the object metadata quantization resolution. Furthermore, in the instance the multi-rate coding model determines a lower coding rate for the encoding of the object direction parameter, there comprises embodiments which can exploit the stability of the object direction parameter across time.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

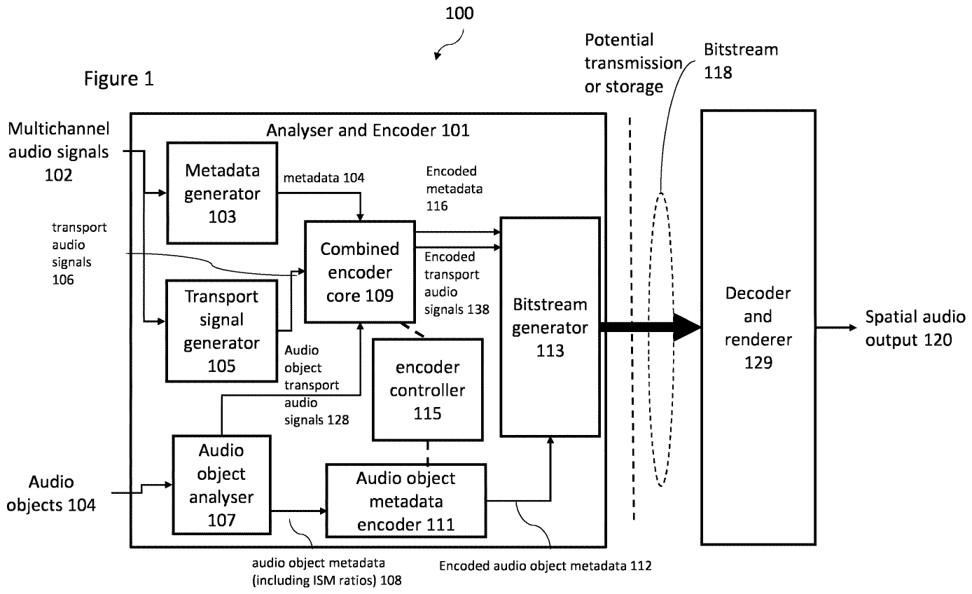

In this regard FIG. 1 depicts an example apparatus 100 and system for implementing embodiments of the application. The system is shown with an ‘analysis’ part. The ‘analysis’ part is the part from receiving the multi-channel signals up to an encoding of the metadata and downmix signal.

The input to the system ‘analysis’ part is the multi-channel audio signals 102. In the following examples a microphone channel signal input is described, however any suitable input (or synthetic multi-channel) format may be implemented in other embodiments. For example, in some embodiments the spatial analyser and the spatial analysis may be implemented external to the encoder. For example, in some embodiments the spatial (MASA) metadata associated with the audio signals may be provided to an encoder as a separate bit-stream. In some embodiments the spatial (MASA) metadata may be provided as a set of spatial (direction) index values.

Additionally, FIG. 1 also depicts multiple audio objects 104 as a further input to the analysis part. As mentioned above these multiple audio objects (or audio object stream) 104 may represent various sound sources within a physical space. Each audio object may be characterized by an audio (object) signal and accompanying metadata comprising directional data (in the form of azimuth and elevation values) which indicate the position or direction of the audio object within a physical space on an audio frame basis.

The multi-channel signals 102 are passed to an analyser and encoder 101, and specifically a transport signal generator 105 and to a metadata generator 103.

In some embodiments the metadata generator 103 is also configured to receive the multi-channel signals and analyse the signals to produce metadata 104 associated with the multi-channel signals and thus associated with the transport signals 106. The analysis processor 103 may be configured to generate the metadata which may comprise, for each time-frequency analysis interval, a direction parameter and an energy ratio parameter and a coherence parameter (and in some embodiments a diffuseness parameter). The direction, energy ratio and coherence parameters may in some embodiments be considered to be MASA spatial audio parameters (or MASA metadata). In other words, the spatial audio parameters comprise parameters which aim to characterize the sound-field created/captured by the multi-channel signals (or two or more audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport signals 106 and the metadata 104 may be passed to a combined encoder core 109.

In some embodiments the transport signal generator 105 is configured to receive the multi-channel signals and generate a suitable transport signal comprising a determined number of channels and output the transport signals 106 (MASA transport audio signals). For example, the transport signal generator 105 may be configured to generate a 2-audio channel downmix of the multi-channel signals. The determined number of channels may be any suitable number of channels. The transport signal generator in some embodiments is configured to otherwise select or combine, for example, by beamforming techniques the input audio signals to the determined number of channels and output these as transport signals.

In some embodiments the transport signal generator 105 is optional and the multi-channel signals are passed unprocessed to a combined encoder core 109 in the same manner as the transport signal are in this example.

The audio objects 104 may be passed to the audio object analyser 107 for processing. In some embodiments the audio object analyser 107 analyses the object audio input stream 104 in order to produce suitable audio object transport signals 128 and audio object metadata 108. For example, the audio object analyser 107 may be configured to produce the audio object transport signals 12 by downmixing the audio signals of the audio objects 104 into a stereo channel together using amplitude panning based on the associated audio object directions. Additionally, the audio object analyser may also be configured to produce the audio object metadata 108 associated with the audio object input stream 104. The audio object metadata may comprise direction values which are applicable for all subbands. So, if there are 4 objects, there are 4 directions. In the examples described herein the direction values also apply across all of the subframes of the frame, but in some embodiments the temporal resolution of the direction values can differ and the directions values apply for one or more than one sub-frames of the frame. Furthermore, energy ratios (or ISM ratios) may be determined for each object. The energy ratio (ISM ratio) defines the contribution of the object within the object part of the total audio environment. In the following examples the energy ratios (or ISM ratios) are for each time-frequency tile for each object.

In some embodiments, the audio object analyser 107 may be sited elsewhere and the audio objects 104 input to the analyser and encoder 101 is audio object transport signals and audio object metadata.

The analyser and encoder 101 may comprise a combined encoder core 109 which is configured to receive the transport audio (for example downmix) signals 106 and audio object transport signals 128 in order to generate a suitable encoding of these audio signals.

The analyser and encoder 101 may also comprise an audio object metadata encoder 111 which is similarly configured to receive the audio object metadata 108 and output an encoded or compressed form of the input information as encoded audio object metadata 112.

In some embodiments the combined encoder core can be configured to implement a stream separation metadata determiner and encoder which can be configured to determine the relative contributory proportions of the multi-channel signals 102 (MASA audio signals) and audio objects 104 to the overall audio scene. This measure of proportionality produced by the stream separation metadata determiner and encoder may be used to determine the proportion of quantizing and encoding “effort” expended for the input multi-channel signals 102 and the audio objects 104. In other words, the stream separation metadata determiner and encoder may produce a metric which quantifies the proportion of the encoding effort expended on the multichannel audio signals 102 compared to the encoding effort expended on the audio objects 104. This metric may be used to drive the encoding of the audio object metadata 108. Furthermore, the metric as determined by the separation metadata determiner and encoder may also be used as an influencing factor in the process of encoding the transport audio signals 106 and audio object transport audio signal 128 performed by the combined encoder core 109. The output metric from the stream separation metadata determiner and encoder can furthermore be represented as encoded stream separation metadata and be combined into the encoded metadata stream from the combined encoder core 109. In some embodiments the analyser and encoder 101 comprises a bitstream generator 113 configured to obtain the encoded metadata 116, the encoded transport audio signals 138 and the encoded audio object metadata 112 and generate the bitstream 118 for potential transmission or storage.

In some embodiments the analyser and encoder 101 comprises an encoder controller 115. The encoder controller 115 can in some embodiments control the encoding implemented by the audio object metadata encoder 111 and the combined encoder core 109. In some embodiments encoder controller 115 is configured to determine the bitrate for the bitstream 118 and based on the bitrate control the encoding. In some embodiments the encoder controller 115 is further configured to control at least one of the audio object analyser 107, transport signal generator 105 and metadata generator 103 in generating parameters.

The analyser and encoder 101 can in some embodiments be a computer or mobile device (running suitable software stored on memory and on at least one processor), or alternatively a specific device utilizing, for example, FPGAs or ASICs. The encoding may be implemented using any suitable scheme. In some embodiments the encoder 107 may further interleave, multiplex to a single data stream or embed the encoded MASA metadata, audio object metadata and stream separation metadata within the encoded (downmixed) transport audio signals before transmission or storage shown in FIG. 1 by the dashed line. The multiplexing may be implemented using any suitable scheme.

Furthermore, with respect to FIG. 1 is shown an associated decoder and renderer 129 which is configured to obtain the bitstream 118 comprising encoded metadata 116, Encoded transport audio signals 138 and encoded audio object metadata 112 and from these generate suitable spatial audio output signals. The decoding and processing of such audio signals are known in principle and are not discussed in detail hereafter other than the decoding of the encoded ISM ratio metadata.

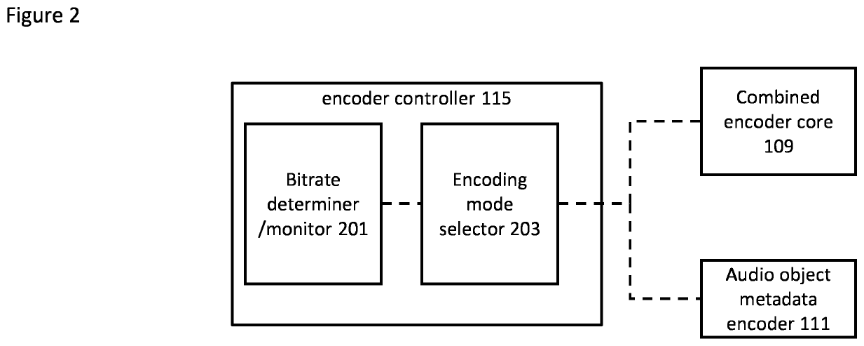

With respect to FIG. 2 is shown in further detail the encoder controller 115 according to some embodiments.

In this example the encoder controller 115 comprises a bitrate determiner/monitor 201 configured to determine and/or monitor the available bitrate for the bandwidth for the encoded audio and metadata. This could be determined based on a transmission path bandwidth estimation (and for example be based on an estimated signal strength) or a bandwidth storage determination to maintain the file for a determined time to be below a required size or by any suitable manner.

The bitrate determiner/monitor 201 can furthermore be configured to control an encoding mode selector 203. The encoder controller 115 can comprise an encoding mode selector 203 configured to select an encoding mode, for example based on the determined bandwidth or bitrate and then control the encoders, for example the combined encoder core 109 and audio object metadata encoder 111.

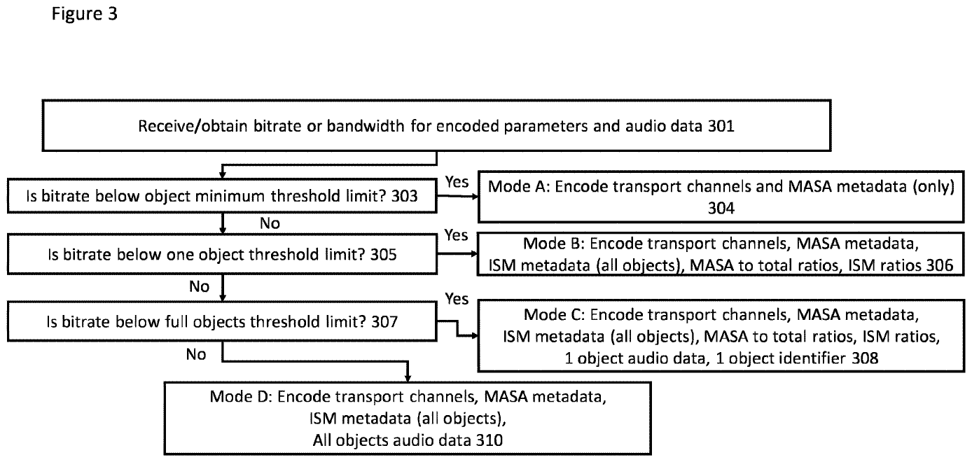

With respect to FIG. 3 is shown a flow diagram of an example operation of the encoder controller 115 shown in FIG. 2. In this example there is an initial operation of receiving or obtaining or otherwise determining the bitrate or bandwidth for encoded parameters and audio data as shown in FIG. 3 by step 301.

Having obtained the available bandwidth or bitrate then a check can be made to determine whether the bitrate is below a first (or lowest or object minimum) threshold limit as shown in FIG. 3 by step 303.

Where the available bandwidth or bitrate is below the first (or lowest or object minimum) threshold limit then the encoders can be controlled to encode the transport channels and MASA metadata only (also shown as Mode A) as shown in FIG. 3 by step 304.

Where the available bandwidth or bitrate is above the first (or lowest or object minimum) threshold limit then a further check can be made to determine whether the bitrate is below a second (or lower or one object) threshold limit as shown in FIG. 3 by step 305.

Where the available bandwidth or bitrate is below the second (or lower or one object) threshold limit then the encoders can be controlled to encode transport channels, MASA metadata, ISM metadata (all objects), MASA to total ratios, ISM ratios (also shown as Mode B) as shown in FIG. 3 by step 306.

Where the available bandwidth or bitrate is above the second (or lower or one object) threshold limit then a further check can be made to determine whether the bitrate is below a third, higher or full object threshold limit as shown in FIG. 3 by step 307.

Where the available bandwidth or bitrate is below the third, higher or full object threshold limit then the encoders can be controlled to encode transport channels, MASA metadata, ISM metadata (all objects), MASA to total ratios, ISM ratios, and 1 object audio data, with 1 object identifier (also shown as Mode C) as shown in FIG. 3 by step 308.

Where the available bandwidth or bitrate is above the third, higher or full object threshold limit then the encoders can be controlled to encode transport channels, MASA metadata, ISM metadata (all objects), All objects audio data (also shown as Mode D) as shown in FIG. 3 by step 310.

The encoding modes can for example be summarised by the following table

| Mode | Bitrate range/Format | Encoded parameters |
|---|---|---|
| A | −32 kbps | transport channels |
| | | MASA metadata |
| B | 48-80 kbps | Transport channels |
| | ISM_MASA_MODE_PARAM | MASA metadata |
| | | ISM metadata |
| | | MASA to total ratios |
| | | ISM ratios |
| C | 96-128 kbps | Transport channels |
| | ISM_MASA_MODE_ONE_OBJ | MASA metadata |
| | | ISM metadata |
| | | MASA to total ratios |
| | | ISM ratios |
| | | 1 object audio data |
| | | 1 object identifier |
| D | 160 - | MASA Transport |
| | ISM_MASA_MODE_DISC | channels |
| | | MASA metadata |
| | | ISM metadata |
| | | all objects audio data |

The bitrates shown herein are examples and it would be understood that they can be other specific values.

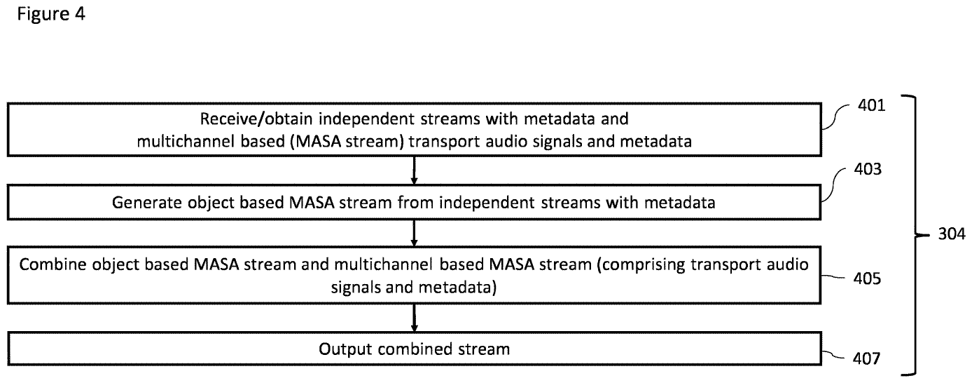

10 With respect to FIGS. 4 to 7 is shown flow diagrams showing a first (or lowest or combined) encoding mode as shown in FIG. 3 by step 304, a second (or lower or object metadata) encoding mode as shown in FIG. 3 by step 306, a third (or higher or one object) encoding mode as shown in FIG. 3 by step 308 and a fourth (or highest or all objects) encoding mode as shown in FIG. 3 by step 310 respectively.

For example, FIG. 4 the mode A encoding method, shows the first (or lowest or combined) encoding mode as shown in FIG. 3 by step 304 in further detail. Thus for very low total bitrates (for example less or equal to 32 kbps) all encoding is implemented using a MASA representation.

Thus, for example there is an operation of receiving/obtaining the object based streams (independent streams with metadata) and multichannel based (MASA stream) transport audio signals and metadata as shown in FIG. 4 by step 401.

Then, as shown in FIG. 4 by step 403, there is an operation of generating an object based MASA stream from the object streams (independent streams with metadata). This object based MASA stream can in some embodiments be created from the object stream using, for example, the methods presented in WO2019086757A1.

After this, as shown in FIG. 4 by step 405, the object based MASA stream and multichannel based MASA stream are combined. In some embodiments the original MASA stream and the MASA stream created from the objects can be combined using the method presented in GB2574238. The decoder gets the objects and the MASA audio content in the MASA format.

Then the combined stream is output as shown in FIG. 4 by step 407. In such embodiments the object audio content (together with the MASA audio content) is present in the decoded audio scene, but the objects cannot be edited nor separated from the scene at the decoder.

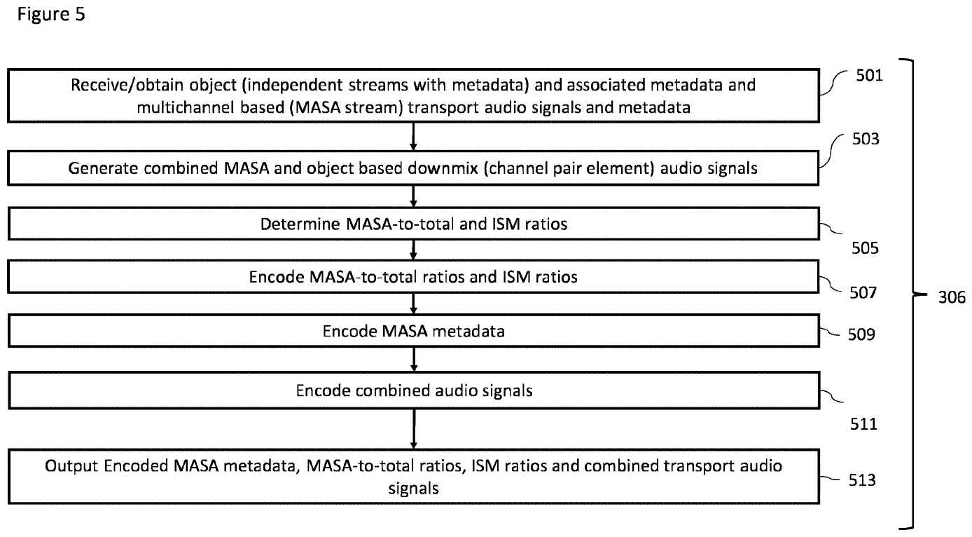

FIG. 5 shows the mode B encoding method, the second (or lower or object metadata) encoding mode as shown in FIG. 3 by step 306. Thus for low bit-rates (for example between 48 kbps and 80 kbps) and since there are a more bits available, there is a possibility to parameterize the audio scene, by sending one common audio data downmix, the MASA metadata, the ISM metadata, and additional parameter sets indicating for each time frequency tile how much of the signal corresponds to the MASA component out of the total audio scene (in other words this can be presented or indicated by the MASA-to-total energy ratios) and ratios indicating how the audio scene corresponding to the objects is distributed between the ISMs (in other words this can be presented or indicated by the ISM ratios).

Thus, for example there is a method step of receiving/obtaining the object based streams (independent streams with metadata) and multichannel based (MASA stream) transport audio signals and metadata as shown in FIG. 5 by step 501.

Then, as shown by step 503 in FIG. 5, generate a combined MASA and object based downmix (channel pair element) audio signals. In other words, the audio content of MASA and the objects is downmixed to 2 channels (channel pair element CPE).

The MASA-to-total ratios and the ISM ratios can be determined as shown in FIG. 5 by step 505.

The MASA-to-total ratios and the ISM ratios can then be encoded based on any suitable encoding method. For example the ISM ratios can be encoded using a lattice encoding or other vector quantization method or the MASA-to-total ratios encoded by DCT transforming followed by entropy coding. (for example such as described in WO2022/200666). The encoding of the MASA-to-total ratios and the ISM ratios is shown in FIG. 5 by step 507.

Furthermore, the MASA metadata can then be encoded based on any suitable MASA metadata encoding method as shown in FIG. 5 by step 509.

The combined audio signals can then be encoded based on any suitable audio signal encoding method as shown in FIG. 5 by step 511.

The encoder can then output Encoded MASA metadata, MASA-to-total ratios, ISM ratios and combined transport audio signals as shown in FIG. 5 by step 513.

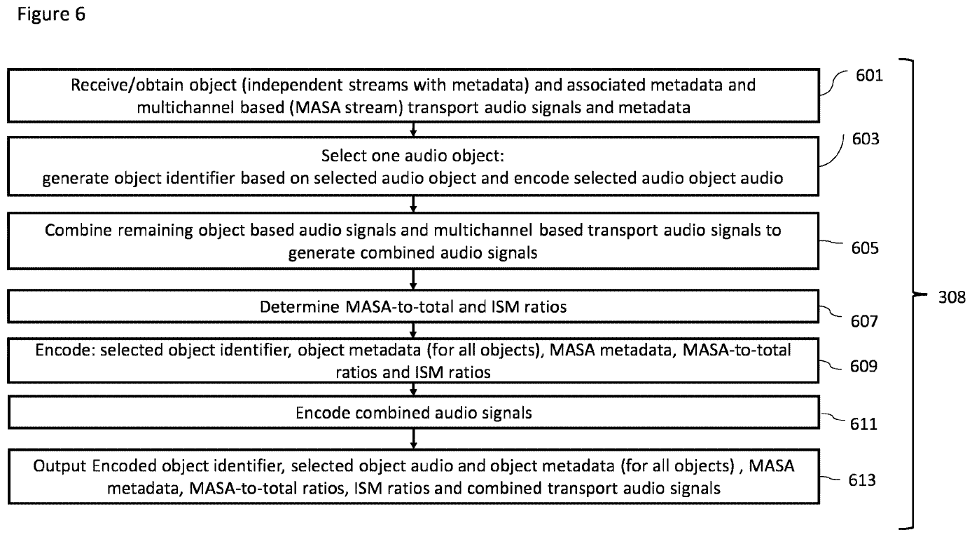

FIG. 6 shows the mode C encoding method, the third (or higher or one object) encoding mode as shown in FIG. 3 by step 308. Thus in medium or higher bitrates (for example bitrates larger or equal to 96 kbps and lower than 160 kbps), the audio content of one object is separated and sent independently. In addition, the downmix formed from the MASA transport channels and the rest of the objects are sent under MASA format with the additional parameters of the MASA-to-total energy ratios and ISM ratios. Moreover, the ISM metadata is sent, and an identifier describing which object was separated. At each frame it is decided which object is to be separated. The decision may, e.g., be based on the relative level of the objects with respect to other objects (e.g., separate the loudest object). This is explained in detail in WO2022/214730.

Thus, for example there is a method step of receiving/obtaining the object based streams (independent streams with metadata) and multichannel based (MASA stream) transport audio signals and metadata as shown in FIG. 6 by step 601.

Then, as shown by step 603 in FIG. 6, one audio object is selected and an object identifier generated based on selected audio object. Furthermore, the audio signal associated with the selected audio object is encoded. Any suitable audio signal encoder may be used for encoding the audio signal of the selected object. For example, the same or similar audio signal encoder as used for encoding the MASA audio signal(s) can be employed. Then a combined MASA and remaining (or non-selected) object based transport audio signals (or downmix) is generated as shown by FIG. 6 by step 605. The object transport signals can be created in the same manner as presented in the previous mode, mode B, with the difference being that the selected or separated object not included within the mix. For example, the multichannel or MASA audio signals and the (non-selected) object transport signals can be summed together to generate the combined transport audio signals.

The MASA-to-total ratios and the ISM ratios can be determined as shown in FIG. 6 by step 607.

The object identifier, MASA metadata, object metadata for all objects, MASA-to-total ratios and the ISM ratios can then be encoded based on any suitable encoding method as shown in FIG. 6 by step 609. For example the encoding can employ any scalar or vector quantizer followed or not by entropy coding. The encoding of the MASA-to-total energy ratio encoding can be implemented in the manner as described in WO2022/200666. The encoding of the ISM ratios is described later in further detail.

The combined audio signals can then be encoded based on any suitable MASA audio signal encoding method as shown in FIG. 6 by step 611. The encoding is of the combined transport audio signals can employ any suitable transport audio signal encoding, for example the MASA encoder.

In other words the separated object is determined, separated and encoded as described in WO2022/214730, and for the remaining objects and the MASA stream the processing works as was described in WO2022/200666.

The encoder can then output the encoded object identifier, MASA metadata, MASA-to-total ratios, ISM ratios, object metadata (for all objects), selected single object audio signal and combined transport audio signals as shown in FIG. 6 by step 613.

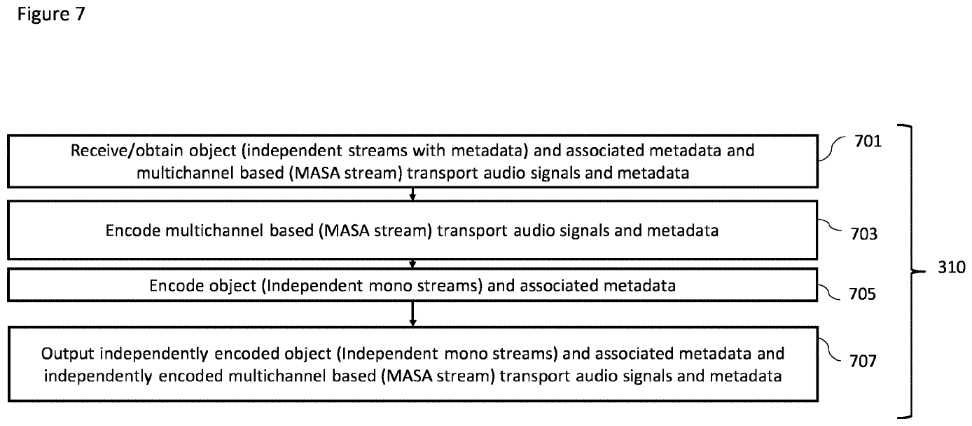

FIG. 7 shows the mode D encoding method, the fourth (or highest or all objects) encoding mode as shown in FIG. 3 by step 310. Thus, in the higher bitrates (for example bitrates above or equal to 160 kbps) the two input audio formats, MASA and ISM are independently encoded and transmitted.

Thus, for example there is a method step of receiving/obtaining the object based streams (independent streams with metadata) and multichannel based (MASA stream) transport audio signals and metadata as shown in FIG. 7 by step 701.

Then, as shown by step 703 in FIG. 7, there is encoded the multichannel based (MASA stream) transport audio signals and metadata based on any suitable MASA encoding method.

The object (independent streams with metadata) and associated metadata can furthermore be encoded as shown in FIG. 7 by step 705. Any suitable mono encoder (as part of the main encoder) can be employed to implement the encoding, for example an EVS based mono encoder.

The encoder can then output the independently encoded object (independent streams with metadata) and associated metadata and independently encoded multichannel based (MASA stream) transport audio signals and metadata as shown in FIG. 7 by step 707.

With respect to the following the generation and encoding of the ISM ratio values, such as determined and encoded within the encoding modes B and C, is described in further detail.

With respect to the following encoding of the direction metadata parameter associated with the objects (as determined from the ISM metadata) is described and in some embodiments the encoding of the direction metadata parameter associated with the objects when the encoder is operating in the modes B and C (the second or third) encoding modes. However, it would be appreciated that in some embodiments the following can also be applied to any encoding mode where the audio object metadata (and specifically the direction metadata) is encoded. In embodiments where the MASA-to-total ratios and ISM ratios are not sent then extra information on the coding details (bit allocation) is sent. Furthermore, in some embodiments, the ratios could, in principle be calculated from the encoded signals, both at the encoder and at the decoder.

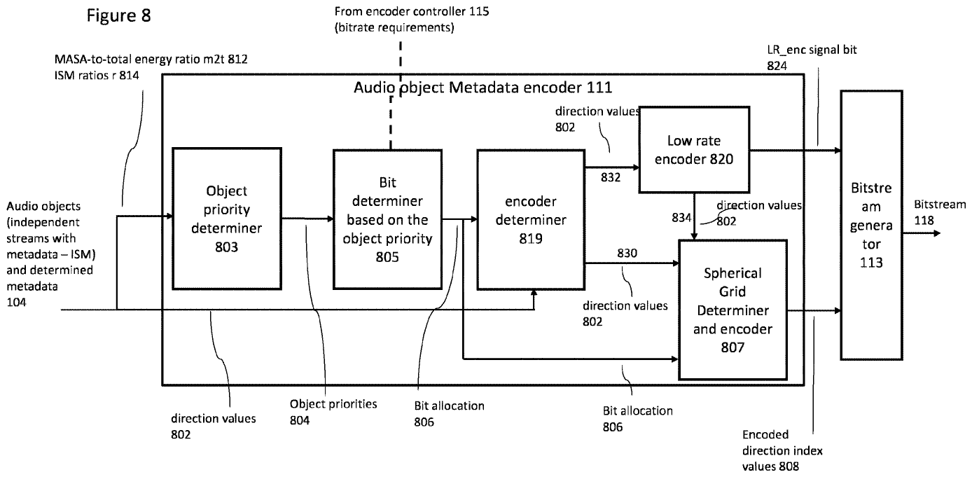

Thus, with respect to FIG. 8 is shown in further detail the audio object metadata encoder 111 according to some embodiments. In the following examples the audio object metadata encoder 111 is configured to receive as an input the ISM metadata and specifically the MASA-to-total energy ratio m2t 812, the ISM ratios r 814 and the direction values 802. In other words the ISM metadata comprises directional information (elevation and azimuth) for each object at each frame. There is a standard resolution of 11 bits per elevation-azimuth pair. Additionally the MASA-to-total ratios and the ISM ratios can be determined or otherwise obtained from the ISM and also from the multichannel audio signals (for example such as described in WO2022/200666).

In some embodiments the ISM ratios can, for example, be obtained as follows.

First, the object audio signals s_{obj}(t, i) are transformed to time-frequency domain S_{obj}(b, n, i) (where t is the temporal sample index, b the frequency bin index, n the temporal frame index, and i the object index. The time-frequency domain signals can, e.g., be obtained via short-time Fourier transform (STFT) or complex-modulated quadrature filterbanks (QMF) (or low-delay variants of them).

Then, the energies of the objects are computed in frequency bands

$${E}_{obj} ( k , n , i ) = {\sum }_{{b}_{k , low}}^{{b}_{k , high}} {\vert {S}_{obj} ( b , n , i ) \vert}^{2}$$

where b_{k,low} is the lowest and b_{k,high} the highest bin of the frequency band k. Then, the ISM ratios ξ(k, n, i) can be computed as

$$ξ ( k , n , i ) = \frac{{E}_{obj} ( k , n , i )}{{\sum }_{i = 0}^{I - 1} {E}_{obj} ( k , n , i )}$$

where I is the number of objects.

In some embodiments, the temporal resolution of the ISM ratios may be different than the temporal resolution of the time-frequency domain audio signals S_{obj}(b, n, i) (i.e., the temporal resolution of the spatial metadata may be different than the temporal resolution of the time-frequency transform). In those cases, the computation (of the energy and/or the ISM ratios) may include summing over multiple temporal frames of the time-frequency domain audio signals and/or the energy values.

The ISM ratios are numbers between 0 and 1 and they correspond to the fraction with which one object is active within the audio scene created by all the objects. For each object there is one ISM ratio per frequency sub-band and time subframe. As discussed above the ISM ratios are passed to the audio object metadata encoder 111.

In some embodiments the audio object metadata encoder 111 is configured to encode the MASA-to-total ratios and the ISM ratios, the specific encoding of the ISM ratios and MASA-to-total ratios are not described herein in any further detail. For example WO2022/200666 describes a suitable MASA-to-total ratio encoding method and GB applications 2217884.2 and 2217905.5 describe suitable ISM ratio encoding method.

In some embodiments there is an (audio) object priority determiner 803. The object priority determiner 803 is configured to generate a priority value for the objects in a time-frequency tile. In some embodiments the object priority determiner 803 is configured to obtain the MASA-to-total ratios 812 and the ISM ratios 814. For each time frequency (TF) tile (meaning for each combination subband-subframe) there is one MASA-to-total energy ratio and N ISM ratios, where N is the number of objects.

The priority value can furthermore in some embodiments be defined as the maximum over all time-frequency tiles of the object contribution ratios.

For example, a priority value can be generated based on

$$p ( i ) = {max}_{{b = 0 : B - 1 ,}_{k = 0 : M - 1}} ( ( 1 - m 2 t ( b , k ) ) r ( i , b , k ) ) , i = 0 : N - 1$$

In the formula above, there are N objects, B subbands, and M time subframes. m2t(b, k) represents the quantized MASA-to-total energy ratio for subband b and subframe k. r (i, b, k) is the quantized ISM ratio of object i, for subband b and subframe k. In the following the quantized versions of the MASA-to-total and ISM ratios are used in order to have the same values available also at the decoder.

In some embodiments some other parameter (than the MASA-to-total energy ratio) can be employed. For example, an objects-to-total energy ratio, which could be something like o2t(b,k)=1-m2t(b,k), and would effectively thus carry the same information.

In such embodiments where the alternative parameter is employed, then the equation above is updated accordingly. Thus, in the above object-to-total energy ratio example the object-to-total o2t(b,k) would just replace the (1-m2t(b,k)) part.

Alternatively, in some embodiments a (weighted) average of the object contributions in the TF tiles can also be considered for selecting the priority. Also, in some other embodiments, the max operator can be replaced by a second or third max value (or any similar value). This way, the highest contribution in a single TF-tile would not alone determine the priority.

The object priority values 804 can then be passed to a bit determiner 805.

In some embodiments the audio object metadata encoder 111 comprises a bit determiner 805. The bit determiner 805 is configured to obtain or receive the object priorities 804 and based on these object priority values determine the number of bits that can be used to encode the direction parameter. In other words set the number of bits which defines the quantization grid used to encode the direction values 802.

In some embodiments the bit determiner 805 is configured to determine or assign fewer bits for objects with lower priority.

As an example, based on the object priority, the number of bits allocated for each object directional metadata can be calculated as:

$$bits ( i ) = 11 - [ ( 1 - p ( i ) ) * 6 ] , i = 0 : N - 1$$

The [ ] operator stands for rounding to the nearest integer operation. The maximum number of bits per object direction is 11 and the minimum number of bits is 4. The maximum number of bits and the minimum number of bits can be other values based on the implementation details and thus the value 7 (the difference between the maximum number of bits and the minimum number of bits per object direction) can also change in some other embodiments. Although this example shows a linear scale the formula described above providing the number of bits can be replaced by any other increasing linear or non linear function of the object priority and ensuring the number of bits are within a domain [4, 11] or similar.

Also shown in FIG. 8 is a low bit rate directional encoder 820 which may be applied to the encoding of audio object directional values when the encoder controller 115 determines a lower coding rate, such as the encoding modes of Mode B and Mode C. This low bit rate directional encoder 820 may be applied, instead of the spherical grid determiner and encoder 807, for the encoding of an audio object direction value. To that end, FIG. 8 also depicts an encoder determiner 819 which is arranged to select between the low bit rate encoder 820 and the spherical grid determiner and encoder 807. The selected encoder is then used to encode a direction value of an audio object.

The selection between the two different encoding schemes may be dependent on the bit allocation 806 for quantizing the direction value. For instance, the encoder determiner 819 can be arranged to receive the bit allocation 806 and test it against a predetermined threshold bit value. The result of the test can then be used to direct the audio object direction value 802 to either the low-rate encoder 820 or the spherical grid determiner and encoder 807. FIG. 8 depicts the deployment of the encoder determiner 819 as being arranged to receive both the bit allocation 806 and the audio object direction value 802 and output the audio object direction value 802 to either of the low-rate encoder 820 or the spherical grid determiner and encoder 807.

In embodiments the encoder determiner 819 may have the following functionality. Initially, the bit allocation 806 may be inspected to determine whether the allocated number of bits for quantizing a particular audio object direction value is below a predetermined threshold bit value. If the allocated number is below the predetermined threshold, then the audio object direction value 802 is directed to the low-rate encoder 820 along the signal feed 832 for encoding. Otherwise, the audio object direction value 802 is directed along the signal feed 830 to the spherical grid determiner and encoder 807 for encoding. The selection between the low bit rate encoder 820 and the spherical grid determiner and encoder 807 may be performed on a per audio object basis.

The above functionality of the encoder determiner 819 may be exemplified by the pseudo code below.

1. For each object i
a. If bits(i) < 8

| | |
|---|---|
| i. | Send unquantized direction values to low rate encoder 820 |
| ii. | End |

b. Else

| | |
|---|---|
| i. | Send unquantized direction values to spherical grid |
| | determiner and encoder 807 |
| ii. | End |

c. End
2. End for

In the above pseudo code it can be seen that the predetermined threshold bit value has been set to 8 bits. However, it is to be appreciated that other values of threshold may be used and that these values may be obtained through experimentation.

Returning to FIG. 8, when the low-rate encoder 820 is selected the encoder is arranged to receive the audio object direction value 802 along the signal feed 832. The low-rate encoder 820 may then be arranged to compare the current frame audio object direction value (Azimuth and elevation) with an audio object direction value for a previous frame across the same audio object. In embodiments this comparison may be performed using the unquantized audio object direction values. If the outcome of the comparison determines that the previous frame audio object direction value is the same as the current frame audio object direction value, then the low-rate encoder 820 is arranged to signal this as a single bit to indicate that there is no change in direction value from the previous frame. This is depicted in FIG. 8 as the LR_enc signal bit 824. In other words, in this instance the encoded audio object direction value for the audio object is a single bit.

Note the comparison is performed on a direction value component basis. That is the current frame azimuth value is compared to the previous frame azimuth value and the current frame elevation value is compared to the previous frame elevation value. If the comparison registers no change (or difference) for both components then the outcome of the comparison determines that the previous frame audio object direction value is the same as the current frame audio object direction value.

A further embodiment may be arranged to have a LR_enc signal comprising a plurality of bits, such embodiments allow for the difference to be determined between the components of the direction values from a previous frame to a current frame. For example, one could adopt a single bit to indicate whether either or both the azimuth and elevation values of the previous frame are the same as either or both the azimuth and elevation values of the current frame. A further bit can be used to indicate if one of the azimuth or elevation values is the same or both azimuth and elevation values are the same from the previous frame to the current frame. If one of the azimuth value or elevation value is the same, then another bit may be used to identify whether it is the azimuth or elevation value is the same from the previous frame to the current frame. This further embodiment may then be arranged to quantize and encode and index the angle (azimuth or elevation) which has changed from the previous frame to the current frame.

In the event that, the outcome of the above comparison for an audio object indicates that the current frame direction value is not the same as the previous frame direction value the low-rate encoder 820 directs the audio object direction value 802 to the spherical grid determiner and encoder 807 along the signal feed 834 for encoding. This condition can be signalled using the opposite state of the above LR_enc signal bit 824.

In terms of pseudo code, the functionality of the low-rate encoder 820 may have the following form

```
    i. If unquantized elevation and azimuth are same as for the previous frame
      1. Send one bit (1) to signal the directions are the same
  ii. Else
      1. Send one bit (0) to signal the directions are not the same
      2. Direct audio object direction value to encoder 807 for encoding
iii. End
```

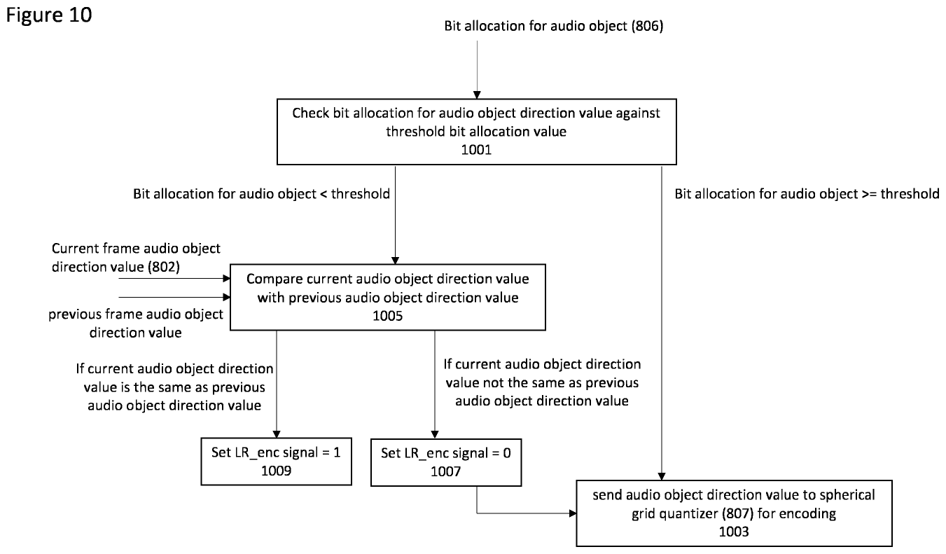

FIG. 10, shows the processing steps of the encoder determiner 819 and the low rate encoder 820.

Initially the bit allocation 806 for an audio object is received by the encoder determiner 819 and then checked against the threshold bit allocation value. This is shown as processing step 1001 in FIG. 10. When processing step 1001 determines that the bit allocation for the audio object is less than the threshold value the encoder determiner 819 determines that the low-rate encoder 820 should be used to encode the audio object direction value. This is depicted in FIG. 10 as the progression to processing step 1005. However, when processing step 1001 determines that the bit allocation is not less than that the threshold value the encoder determiner 819 will determine that the spherical grid quantizer 807 is to be directly used for encoding the audio object direction value 802. This is depicted in FIG. 10 as the progression to processing step 1003, resulting in the audio object direction value 802 being sent directly to the spherical grid quantizer 807 for encoding.

At processing step 1005, the low-rate encoder 820 compares the current frame audio object direction value with a previous frame audio object direction value in order to determine whether the audio object direction value 802 should be sent to the spherical grid quantizer 807 for encoding. In the event the comparison indicates that the current frame audio object direction value is the same as previous frame audio object direction value, the audio object direction parameter is not to the spherical grid quantizer 807 for encoding. Instead, the current frame audio object direction parameter 802 is not encoded per se, rather the state of LR_enc signal bit 824 is set to a state that indicates current frame audio object direction value 802 is the same as the audio object direction value for the previous frame. This is reflected in FIG. 10 as the progression to step 1009.

In the event the comparison at step 1005 indicates that that the two direction values are not the same the low-rate encoder 820 determines that the current frame audio object direction value is sent to the Spherical grid quantizer 807 for encoding. This is depicted in FIG. 10 as the transition from processing step 1005 to processing step 1003 via the step 1007. At step 1007, the low-rate encoder 820 is arranged to set the state of LR_enc signal 824 to indicate that the current frame and previous frame audio object direction values differ.

The low-rate encoder 820 can be configured to output the LR_Enc signal bit 824 to the bit stream generator 113, in order to be included in the bitstream 118.

As indicated above the audio object metadata encoder 111 comprises a spherical grid determiner and encoder 807 configured to receive the bit allocation 806 and the direction values 802. The spherical grid determiner and encoder 807 is then configured to generate an output index value based on the nearest point with respect to the direction values 802 in a determined spherical grid defined by the bit allocation 806 for the audio object. The encoded direction index values 808 for the audio object may then be passed to the bitstream generator 113 for inclusion into the bitstream 113.

Other embodiments may be configured to quantize the direction of each object, with the corresponding number of bits and output an elevation index and an azimuth index. The object metadata can be independently encoded for each object or jointly encoding the objects directional metadata using for instance some weights to correspond to the different bit allocations.

The spherical grid uses the idea of covering a sphere with smaller spheres and considering the centres of the smaller spheres as points defining a grid of almost equidistant directions. Each point on the grid is defined by the pairing of an azimuth value and an elevation value.

The highest resolution (11 bits) spherical grid used for the direction quantization ensures a quantization resolution of 5 degrees. The structure of the spherical grid is the same as the one used for the quantization of the MASA directional metadata (and methods for defining the grid and encoding the index with respect to MASA directional metadata values are known as discussed in PCT/EP2017/078948, GB1811071.8).

In some embodiments where the priority of an object is exactly zero, the number of bits for that object is set to zero and there is no directional metadata sent for that object.

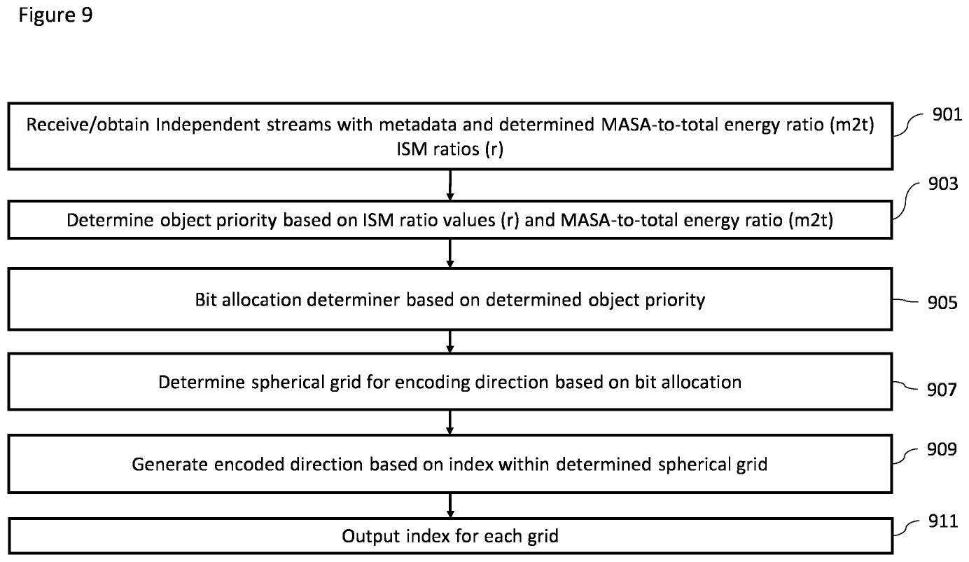

With respect to FIG. 9 is shown a flow diagram which summarises the operations of the example audio object metadata encoder 111 shown in FIG. 8.

The initial operation is one of receiving/obtaining the independent streams with metadata and determined (quantized) MASA-to-total energy ratio (m2t) and ISM ratios (r) as shown in FIG. 9 by step 901.

Then the following operation is determining object priority based on (quantized) ISM ratio values (r) and (quantized) MASA-to-total energy ratio (m2t) as shown in FIG. 9 by step 903.

Having determined the object priority then determine bit allocations for the direction parameter based on determined object priority as shown in FIG. 9 by step 905.

From the bit allocations then determine a spherical grid for encoding direction parameters for the objects as shown in FIG. 9 by step 907.

Then generate encoded direction index within the determined spherical grids as shown in FIG. 9 by step 909.

The encoded direction index values can then be output for inclusion to the bitstream as shown in FIG. 9 by step 911.

With respect to a decoder, the decoding of the encoded directional information can be implemented by determining a similar priority ordering determination and determining the associated quantization grid. Thus, for example an encoding and decoding pseudo-code representation can be:
Object metadata encoding
1. For each object
   a. calculate priority p(i)
   b. calculate the number of bits bits(i)
2. End for
3. For each object
   a. Encode the directional metadata in the spherical grid corresponding to the number of bits allocated for the object
4. End for
Object metadata decoding
1. For each object
   a. calculate priority p(i)
   b. calculate the number of bits bits(i)
2. End for
3. For each object
   a. Decode the directional metadata in the spherical grid corresponding to the number of bits allocated for the object
4. End for

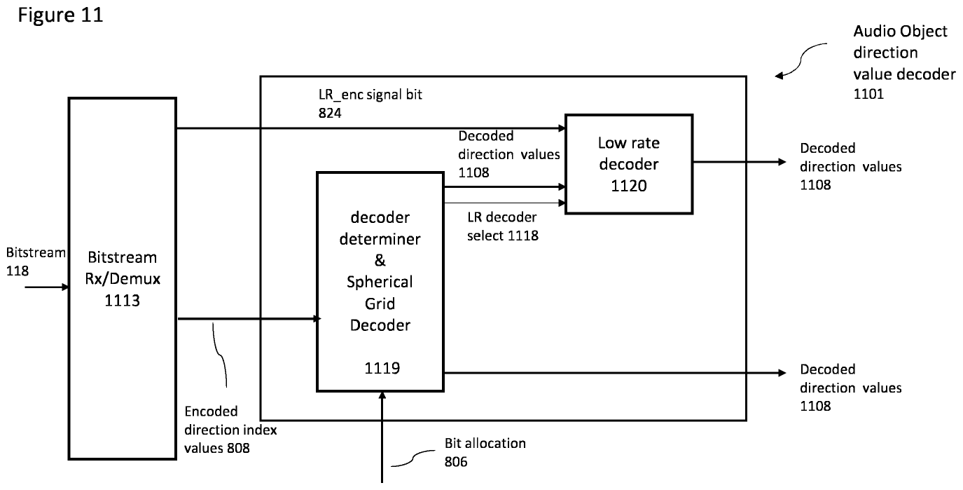

With respect to FIG. 11 there is shown an audio direction value decoder 1101 and a bitstream receiver and demultiplexer 1113. The bitstream receiver and demultiplexer 1113 is arranged to receive and demultiplex the encoded bitstream 118 into various signal streams of encoded parameters, of which FIG. 11 depicts those encoded streams which are pertinent to the audio direction value decoder 1101.

The audio direction value decoder 1101 is shown as comprising a decoder determiner & spherical grid decoder 1119 and a low-rate decoder 1120. The decoder determiner & spherical grid decoder 1119 is arranged to receive the encoded direction index values 808 and the bit allocation 806 corresponding to an audio object.

The bit allocation 806 for an audio object i can be determined locally at the decoder by determining the priority value p(i) for the audio object. The priority value can be determined from the ISM ratio for the audio object. The ISM ratio is sent to the decoder as part of the bitstream 118.

The decoder determiner & spherical grid decoder 1119 is initially arranged (for each audio object) to compare the bit allocation 806 for the audio object to the predetermined threshold bit value in order to determine whether the decoded direction values 1108 are obtained either by directly decoding the encoded direction index or by utilizing the functionality of the low-rate decoder 1120. In other words when the bit allocation 806 is below the threshold the low-rate decoder 1120 is selected to form the decoded direction values 1108. This is depicted in FIG. 11 as the signal feed LR decoder select 1118. Conversely, when the bit allocation 806 is not below the threshold the decoded direction values 1108 are generated directly by the decoder determiner & spherical grid decoder 1119.

The above functionality of the decoder determiner & spherical grid decoder 1119 may be exemplified by the pseudo code below.

```
For each object i
  If bits(i) < 8
      i. Select low-rate decoder
      ii. End
  Else
      i. Decode encoded direction index value
    ii. End
  End if
```

When the low-rate decoder 1120 is selected for decoding the audio direction values for an audio object, the Low-rate decoder 1120 is arranged to initially inspect the value of the LR_enc signal bit 824. In the instance that the state of the LR_enc_signal bit 824 indicates that there is no change in direction value [for the audio object] between the previous audio frame and the current audio frame (LR_enc_signal=1), the low-rate decoder 1120 will simply output the previous frame's direction value [for the audio object] as the audio object's direction value for the current frame.

It is to be noted that the spherical grid decoder sited in the decoder determiner & spherical grid decoder 1119 is arranged to decode the audio object encoded direction index values in accordance with the bit allocation 806 for the audio object.

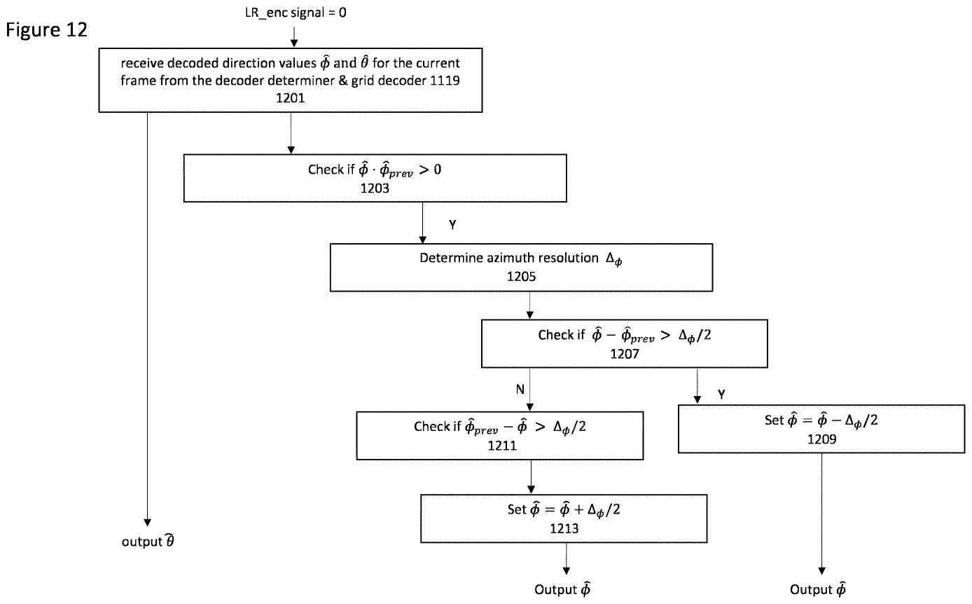

Conversely, in the instance that the LR_enc_signal bit 824 indicates that the direction values for the audio object between the previous frame and the current frame differ, the low-rate decoder 1120 is arranged to operate in a different manner, and in this respect FIG. 12 depicts the processing performed by the low-rate decoder 1120.

Firstly, the low-rate decoder 1120 is configured to receive decoded direction values \hat{φ} and \hat{θ} for the current frame from the decoder determiner & spherical grid decoder 1119. This is shown as processing step 1201.

The low-rate decoder 1120 then checks if the multiple of the current frame quantized azimuth (direction) value \hat{φ} and the previous frames quantized azimuth value \hat{φ}ₚᵣₑᵥ are above zero. This is shown as processing step 1203 in FIG. 12.

When the check at processing step 1203 indicates that the product of \hat{φ}·\hat{φ}ₚᵣₑᵥ>0, the low-rate encoder 1120 is then configured to move to processing step 1205 where the azimuth quantization resolution is determined. This can be determined to be the distance between azimuth points around the circumference of a circle of the spherical grid, where the circle is given by the elevation value \hat{θ}. The resolution of the azimuth value can be found as

$${Δ}_{ϕ} = 360 / {n}_{θ}$$

Where n_{θ} is the number of azimuth points around the circumference of the circle for the elevation \hat{θ} and coincides with the number of azimuth values in the codebook corresponding to the elevation \hat{θ}.

Once the resolution is found the process performs a further check at step 1207 to determine whether the difference between the current frame quantized azimuth (direction) value \hat{φ} and the previous frames quantized azimuth value Øprev is greater than half the azimuth resolution Δ_{φ}/2 (\hat{φ}−\hat{φ}ₚᵣₑᵥ>Δ_{φ}/2). If this is determined to be the case then the current frame azimuth value is set to the difference between the current frame azimuth value and half the azimuth resolution, \hat{φ}=\hat{φ}−Δ_{φ}/2. This is shown as processing step 1209 in FIG. 12.

However, if the condition of the check at processing step 1207 is not met, then the process proceeds to a further check at processing step 1211. At this step the difference between the previous frame quantized azimuth (direction) value \hat{φ}ₚᵣₑᵥ and the current frame quantized azimuth value \hat{φ} is taken and the result is checked to determine if it is greater than half the azimuth resolution Δ_{φ}/2 (\hat{φ}ₚᵣₑᵥ−\hat{φ}>Δ_{φ}/2). If this condition is met then the current frame azimuth value is set to the sum of the current frame azimuth value and half the azimuth resolution, =\hat{φ}+Δ_{φ}/2. This is shown as the processing step 1213 in FIG. 12.

To summarize. The overall effect of the processing steps of FIG. 12, that is the case of when the state of the LR_enc_signal bit indicates that there is a change in direction values [for the audio object] between the previous audio frame and the current audio frame (LR_enc_signal=0, FIG. 12), the low-rate decoder 1120 will produce as output decoded direction values comprising the decoded elevation value \hat{θ} and decoded azimuth value \hat{φ} which has been changed by either adding the value Δ_{φ}/2 or subtracting the value Δ_{φ}/2. When the state of the LR_enc_signal bit indicates that there is no change in direction values [for the audio object] between the previous audio frame and the current audio frame (LR_enc_signal=1), the low-rate decoder 1120 will produce as output decoded direction values comprising the decoded direction values from the previous audio frame

The function of the low-rate decoder 1120 may also be exemplified by the following pseudo code.

```
i. Read one bit, LR_enc_signal bit, from bitstream
ii. If LR_enc_signal == 1
  1. Direction is same as for previous frame
iii. Else
  1. Receive direction index
  2. Decode the direction index into \hat{φ} and \hat{θ}
  3. If \hat{φ} · \hat{φ}ₚᵣₑᵥ > 0
    a. Δ_{φ} = 360/n_{θ}
    $b . If \hat{ϕ} - {\hat{ϕ}}_{prev} > \frac{{Δ}_{phi}}{2}$
      i. \hat{φ} = \hat{φ} − Δ_{φ}/2
    $c . Else if {\hat{ϕ}}_{prev} - \hat{ϕ} > \frac{{Δ}_{phi}}{2}$
      i. \hat{φ} = \hat{φ} + Δ_{φ}/2
    d. End
  4. End if
iv End if
```

With respect to FIG. 10 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder/analyser part and/or the decoder part as shown in FIG. 1 or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor and at least one memory storing instructions that, when executed by the at least one processor, cause the apparatus at least to:
receive a direction value for a time frame of an audio object;
compare, as a first comparison, a bit allocation against a threshold bit allocation value;
depending on the first comparison, either quantize the direction value for the time frame of the audio object with a quantizer according to the bit allocation, or compare, as a second comparison, the direction value for the time frame of the audio object with a direction value for a previous time frame of the audio object; and
depending on the second comparison quantize the direction value for the time frame with the quantizer according to the bit allocation and signal the second comparison.

2. The apparatus as claimed in claim 1, wherein the apparatus being caused to depending on the second comparison quantize the direction value for the time frame with the quantizer according to the bit allocation and signal the comparison comprises the apparatus being caused to:
quantize the direction value for the time frame with the quantizer according to the bit allocation when the second comparison indicates the direction value for the time frame of the audio object is different from the direction value for the previous time frame of the audio object and set a signal flag to indicate that the direction value for the time frame differs from the direction value for the previous time frame; and
set a signal flag to indicate that the direction value for the time frame is the same as the direction value for the previous time frame when the second comparison indicates the direction value for the time frame of the audio object is the same as the direction value for the previous time frame of the audio object.

3. The apparatus as claimed in claim 1, wherein the apparatus being caused to depending on the first comparison, either quantize the direction value for the time frame of the audio object with a quantizer according to the bit allocation, or compare, as a second comparison, the direction value for the time frame of the audio object with a direction value for a previous time frame of the audio object comprises the apparatus being caused to:
quantize the direction value for the time frame of the audio object with a quantizer according to the bit allocation when the bit allocation for the quantization of the direction value is not less than the threshold bit allocation value; and
compare the direction value for the time frame of the audio object with a direction value for a previous time frame of the audio object as the second comparison when the bit allocation for the quantization of the direction value is less than the threshold bit allocation value.

4. The apparatus as claimed in claim 1, wherein the quantizer is a spherical grid quantizer, wherein the spherical grid is formed by covering the sphere with smaller spheres, wherein the smaller spheres define the points of the spherical grid.

5. The apparatus as claimed in claim 1, wherein the direction value comprises an azimuth value and an elevation value.

6. An apparatus comprising at least one processor and at least one memory storing instructions that, when executed by the at least one processor, cause the apparatus at least to:
compare a bit allocation for a direction value index for a time frame of an audio object against a threshold bit allocation value;
depending on the comparison, either decode the direction value index for the time frame of the audio object with a de-quantizer according to the bit allocation, or read a state of a signal flag associated with the direction value index for the time frame of the audio object; and
depending on the state of the signal flag;
either set a quantized direction value for the time frame of the audio object to be a quantized direction value for a previous time frame of the audio object, or
decode the direction value index for the time frame of the audio object with a de-quantizer according to the bit allocation giving a quantized direction value for the time frame of the audio object and adjust an azimuth value of the quantized direction value for the time frame of the audio object in accordance with a quantization resolution of the azimuth value.

7. The apparatus as claimed in claim 6, wherein the apparatus being caused to adjust an azimuth value of the quantized direction value for the time frame of the audio object in accordance with a quantization resolution of the azimuth value comprises the apparatus being caused to:
compare the product of the azimuth value of the quantized direction value for the time frame and an azimuth value of the quantized direction value for the previous time frame of the audio object, and when the product is greater than zero:
determine a difference between two consecutive azimuth quantization values of the de-quantizer;
when a difference between the azimuth value of the quantized direction value for the time frame and the azimuth value of the quantized direction value for the previous time frame of the audio object is greater than half the difference between two consecutive azimuth quantization values of the de-quantizer subtract the half difference between two consecutive azimuth quantization values of the de-quantizer from the azimuth value of the quantized direction value for the time frame of the audio object; and
when a difference between the azimuth value of the quantized direction value for the previous time frame and the azimuth value of the quantized direction value for the time frame of the audio object is greater than half the difference between two consecutive azimuth quantization values of the de-quantizer add the half difference between two consecutive azimuth quantization values of the de-quantizer to the azimuth value of the quantized direction value for the time frame of the audio object.

8. The apparatus as claimed in claim 7, wherein the apparatus being caused to determine a difference between two consecutive azimuth quantization values of the de-quantizer comprises the apparatus being caused to:
divide the circumference of a circle by a number of azimuth values, where the number of azimuth values is determined by the elevation value of the quantized direction value for the time frame.

9. The apparatus as claimed in claim 6, wherein the state of the signal flag indicates one of:
a direction value for the time frame of the audio object differs from a direction value for the previous time frame of the audio object; or
a direction value for the time frame of the audio object is the same as a direction value for the previous time frame of the audio object;

10. The apparatus as claimed in claim 6, wherein the de-quantizer is a spherical grid quantizer, wherein the spherical grid is formed by covering the sphere with smaller spheres, wherein the smaller spheres define the points of the spherical grid.

11. A method comprising:
receiving a direction value for a time frame of an audio object;
comparing, as a first comparison, a bit allocation against a threshold bit allocation value;
depending on the first comparison, either quantizing the direction value for the time frame of the audio object with a quantizer according to the bit allocation, or comparing, as a second comparison, the direction value for the time frame of the audio object with a direction value for a previous time frame of the audio object; and
depending on the second comparison quantizing the direction value for the time frame with the quantizer according to the bit allocation and signaling the second comparison.

12. The method as claimed in claim 11, wherein depending on the second comparison quantize the direction value for the time frame with the quantizer according to the bit allocation and signal the comparison comprises:
quantizing the direction value for the time frame with the quantizer according to the bit allocation when the second comparison indicates the direction value for the time frame of the audio object is different from the direction value for the previous time frame of the audio object and set a signal flag to indicate that the direction value for the time frame differs from the direction value for the previous time frame; and
setting a signal flag to indicate that the direction value for the time frame is the same as the direction value for the previous time frame when the second comparison indicates the direction value for the time frame of the audio object is the same as the direction value for the previous time frame of the audio object.

13. The method as claimed in claim 11, wherein depending on the first comparison, either quantizing the direction value for the time frame of the audio object with a quantizer according to the bit allocation, or comparing, as a second comparison, the direction value for the time frame of the audio object with a direction value for a previous time frame of the audio object comprises:
quantizing the direction value for the time frame of the audio object with a quantizer according to the bit allocation when the bit allocation for the quantization of the direction value is not less than the threshold bit allocation value; and
comparing the direction value for the time frame of the audio object with a direction value for a previous time frame of the audio object as the second comparison when the bit allocation for the quantization of the direction value is less than the threshold bit allocation value.

14. The method as claimed in claim 11, wherein the quantizer is a spherical grid quantizer wherein the spherical grid is formed by covering the sphere with smaller spheres, wherein the smaller spheres define the points of the spherical grid.

15. The method as claimed in claim 11, wherein the direction value comprises an azimuth value and an elevation value.

16. A method comprising:
comparing a bit allocation for a direction value index for a time frame of an audio object against a threshold bit allocation value;
depending on the comparison, either decoding the direction value index for the time frame of the audio object with a de-quantizer according to the bit allocation, or reading a state of a signal flag associated with the direction value index for the time frame of the audio object; and depending on the state of the signal flag;
either setting a quantized direction value for the time frame of the audio object to be a quantized direction value for a previous time frame of the audio object, or
decoding the direction value index for the time frame of the audio object with a de-quantizer according to the bit allocation giving a quantized direction value for the time frame of the audio object and adjusting an azimuth value of the quantized direction value for the time frame of the audio object in accordance with a quantization resolution of the azimuth value.

17. The method as claimed in claim 16, wherein adjusting an azimuth value of the quantized direction value for the time frame of the audio object in accordance with a quantization resolution of the azimuth value comprises:
comparing the product of the azimuth value of the quantized direction value for the time frame and an azimuth value of the quantized direction value for the previous time frame of the audio object, and when the product is greater than zero:
determining a difference between two consecutive azimuth quantization values of the de-quantizer;
when a difference between the azimuth value of the quantized direction value for the time frame and the azimuth value of the quantized direction value for the previous time frame of the audio object is greater than half the difference between two consecutive azimuth quantization values of the de-quantizer subtracting the half difference between two consecutive azimuth quantization values of the de-quantizer from the azimuth value of the quantized direction value for the time frame of the audio object; and
when a difference between the azimuth value of the quantized direction value for the previous time frame and the azimuth value of the quantized direction value for the time frame of the audio object is greater than half the difference between two consecutive azimuth quantization values of the de-quantizer adding the half difference between two consecutive azimuth quantization values of the de-quantizer to the azimuth value of the quantized direction value for the time frame of the audio object.

18. The method as claimed in claim 17, wherein determining a difference between two consecutive azimuth quantization values of the de-quantizer comprises:
dividing the circumference of a circle by a number of azimuth values, where the number of azimuth values is determined by the elevation value of the quantized direction value for the time frame.

19. The method as claimed in claim 16, wherein the state of the signal flag indicates one of:
a direction value for the time frame of the audio object differs from a direction value for the previous time frame of the audio object; or
a direction value for the time frame of the audio object is the same as a direction value for the previous time frame of the audio object;

20. The method as claimed in claim 16, wherein the de-quantizer is a spherical grid quantizer wherein the spherical grid is formed by covering the sphere with smaller spheres, wherein the smaller spheres define the points of the spherical grid.

21. The apparatus as claimed in claim 5, wherein the second comparison is performed on a direction value component basis, comprising that the azimuth value of the direction value for the time frame of the audio object is compared to an azimuth value of the direction value for the previous time frame of the audio object, and that the elevation value of the direction value for the time frame of the audio object is compared to an elevation value of the direction value for the previous time frame of the audio object.

22. The apparatus as claimed in claim 1, wherein the instructions, when executed by the at least one processor, further cause the apparatus to:
generate a priority value for the audio object; and
determine the bit allocation based on the priority value for the audio object.

23. The apparatus as claimed in claim 22, wherein the apparatus being caused to determine the bit allocation based on the priority value for the audio object comprises the apparatus being caused to:
determine the bit allocation bits (i) based on the priority value p(i) for the audio object i according to an increasing linear or non-linear function of the priority value p(i), ensuring that the bit allocation is within a fixed domain between a minimum number of bits and a maximum number of bits.

24. The apparatus as claimed in claim 1, wherein the threshold bit allocation value is predetermined to be 8 bits.

25. The apparatus as claimed in claim 1, wherein the bit allocation is a number of bits which defines the quantization grid used to encode the direction value.

26. The apparatus as claimed in claim 6, wherein the quantized direction value comprises an azimuth value and an elevation value.

27. The apparatus as claimed in claim 6, wherein the instructions, when executed by the at least one processor, further cause the apparatus to:
generate a priority value for the audio object; and
determine the bit allocation based on the priority value for the audio object.

28. The apparatus as claimed in claim 27, wherein the apparatus being caused to determine the bit allocation based on the priority value for the audio object comprises the apparatus being caused to:
determine the bit allocation bits (i) based on the priority value p(i) for the audio object i according to an increasing linear or non-linear function of the priority value p(i), ensuring that the bit allocation is within a fixed domain between a minimum number of bits and a maximum number of bits.

29. The apparatus as claimed in claim 6, wherein the threshold bit allocation value is predetermined to be 8 bits.

30. The apparatus as claimed in claim 6, wherein the bit allocation is a number of bits which defines the quantization grid used to decode the direction value index.

31. The method as claimed in claim 15, wherein the second comparison is performed on a direction value component basis, comprising that the azimuth value of the direction value for the time frame of the audio object is compared to an azimuth value of the direction value for the previous time frame of the audio object, and that the elevation value of the direction value for the time frame of the audio object is compared to an elevation value of the direction value for the previous time frame of the audio object.

32. The method as claimed in claim 11, further comprising:
generating a priority value for the audio object; and
determining the bit allocation based on the priority value for the audio object.

33. The method as claimed in claim 32, wherein the determining of the bit allocation based on the priority value for the audio object comprises:
determining the bit allocation bits (i) based on the priority value p(i) for the audio object i according to an increasing linear or non-linear function of the priority value p(i), ensuring that the bit allocation is within a fixed domain between a minimum number of bits and a maximum number of bits.

34. The method as claimed in claim 11, wherein the threshold bit allocation value is predetermined to be 8 bits.

35. The method as claimed in claim 11, wherein the bit allocation is a number of bits which defines the quantization grid used to encode the direction value.

36. A bitstream comprising, for a time frame, for each of a plurality of audio objects, a respective encoded direction value, the respective direction value being encoded according to the method of claim 11.

37. The bitstream of claim 36, the bitstream comprising for the time frame:
an encoded object identifier of an audio object selected from the plurality of audio objects;
an encoded audio signal associated with the selected audio object;
an encoded downmix formed from metadata-assisted spatial audio, MASA, transport audio signals and transport audio signals associated with non-selected objects of the plurality of objects;
encoded MASA metadata;
encoded MASA-to-total ratios;
encoded independent stream with metadata, ISM, ratios determined for each object in the plurality of objects; and
encoded object metadata for each object in the plurality of audio objects, wherein the encoded object metadata comprises the encoded direction values for the time frame.
